(19) United States
(12) Patent Application Publication
(10) Pub. No.: US 2002/0069283 A1
(43) Pub. Date: Jun. 6, 2002

(54) Apparatus and method for providing communication service based on personal identifier in internet network

(76) Inventor: Dong Myun Lee, Daejeon-shi (KR)

Correspondence Address: MERCHANT & GOULD PC, P.O. BOX 2903, MINNEAPOLIS, MN, 55402-0903, US

(21) Appl. No.: 09/747,324

(22) Filed: Dec. 21, 2000

(30) Foreign Application Priority Data
Dec. 6, 2000 (KR) 2000-74019

(51) Int. Cl. G06F 15/16

(52) U.S. Cl. 709/227; 709/237

(57) ABSTRACT

The present invention relates to a communication service apparatus based on a personal identifier in an internet network and a method of the same. In the present invention, it is possible to identify a URL of a personal home page, an e-mail account and a currently used terminal by registering an unique personal identifier and to access using only personal identifier irrespective of a location of an internet user and a variation of a user terminal. In addition, a real time communication between subscribers is implemented. In addition, it is possible to manage various internet application services (home page, e-mail, etc.) that a subscriber has in the internet using a unique personal identifier.

### BACKGROUND OF THE INVENTION

1. Field of the Invention

The present invention relates to an apparatus and method for providing a communication service based on a personal identifier in an internet network, and in particular to an improved apparatus and method for providing a communication service based on a personal identifier in an internet network which makes it possible a user to communicate with another user in the internet based on a uniform and unique personal identifier information at a certain terminal(for example, a personal computer) connected with the internet.

2. Description of the Background Art

In the internet, a communication method is generally implemented using a terminal identifier of a certain terminal connected with an internet network. At this time, a certain packet is transferred from a transmission terminal to an Internet protocol address of a receiving terminal, which packet is transferred based on a router connected with an internet network.

An identifier which identifies a certain terminal except for the internet protocol address in the internet is a domain name. The domain name of a terminal (transmission terminal, receiving terminal) is managed by a DNS (Domain Name System) and is converted into an internet protocol address of a terminal thereby.

Therefore, the domain name of a receiving terminal transferred from a transmission terminal is converted into an internet protocol address by the DNS, so that a packet is transferred to a corresponding internet protocol address of the receiving terminal.

In the above-described communication method, a domain name must be allocated to the terminal connected with the internet network, and a certain interrelationship between the domain name and the internet address must be registered in the DNS for thereby implementing an internet communication.

In the above-described communication method using a terminal identifier in the internet, in the case of a terminal which uses a dynamic internet protocol address, the terminal does not have a unique terminal identifier such as a domain name and an internet protocol address.

Therefore, it is impossible to obtain a communication based on a unique terminal identifier. In addition, a continuous communication is not implemented based on a uniform identifier based on the movement of a user.

In the case of a terminal which has a fixed internet protocol address, since an information concerning an interrelationship between a terminal and a user of the terminal does not exist in the internet, an interrelationship with the terminal is disconnected based on the movement of a user. Therefore, it is impossible to implement a communication between the users based on a unique identifier.

Since an internet user does not use only one terminal for a long period, a real time communication between the users is not obtained at a certain time.

An internet user may have a plurality of presence points in the internet, for example, more than one e-mail address or more than one web page for a real time multimedia communication and an e-mail communication with a certain terminal in the internet. In this case, the internet user uses another type identifier, so that it is impossible to implement a communication with a certain user based on a unique personal identifier.

### SUMMARY OF THE INVENTION

Accordingly, it is an object of the present invention to provide an apparatus and method for providing a communication service based on a personal identifier in an internet network which are capable of implementing a communication between users even when the users are located at any place in the internet.

To achieve the above objects, there is provided an apparatus for providing a communication service based on a personal identifier in an internet network in the apparatus providing a communication between users using a terminal connected with an internet network based on a connection with an internet service provider network by receiving a static internet protocol address or a dynamic internet protocol address, which includes a user information management means connected with the internet network for providing a unique personal identifier to a user and providing a communication service based on the personal identifier information, wherein said user information management unit includes a user information service unit for verifying a user information based on the personal identifier information and providing a service that a user wants, to a user's terminal through the internet network, and a user information storing unit connected with the user information service unit for storing the personal identifier and user information.

To achieve the above objects, there is provided a method for providing a communication service based on a personal identifier in an internet network in an apparatus providing a communication between users using a terminal connected with an internet network based on a connection with an internet service provider network by receiving a static internet protocol address or a dynamic internet protocol address, which includes a user information service providing step in which an internet network is connected for providing a unique personal identifier to a user and providing a communication service based on the personal identifier information, wherein said user information service providing step includes, a first step for receiving a personal identifier information, a verification information and a user information service request message from a user which are needed for a user verification, a second step for verifying a user based on the personal identifier and verification information, a third step for performing a user information service based on the type of each user information service request message, and a fourth step for transferring a result message obtained based on an execution of the user information service to the user in accordance with the type of the user information service request message.

### BRIEF DESCRIPTION OF THE DRAWINGS

The present invention will become better understood with reference to the accompanying drawings which are given only by way of illustration and thus are not limitative of the present invention, wherein;

FIG. 1 is a schematic block diagram illustrating an apparatus for providing a communication service based on a personal identifier in an internet network according to an embodiment of the present invention;

FIG. 2 is a view illustrating an operation based on a user information management unit of FIG. 1;

FIG. 3 is a view illustrating the construction of a user information internet protocol packet for a user information registration of FIG. 2;

FIG. 4 is a flow chart of an operation procedure based on a user information management request of FIG. 2;

FIG. 5 is a flow chart of an operation procedure based on a user information inquiry request of FIG. 2;

FIG. 6 is a flow chart of an operation procedure based on a user information deletion request of FIG. 2;

FIG. 7 is a flow chart of an operation procedure based on a user information management request of FIG. 2; and

FIG. 8 is a flow chart of a user information transmission procedure of FIG. 4.

### DETAILED DESCRIPTION OF THE PREFERRED EMBODIMENTS

The embodiments of the present invention will be explained with reference to the accompanying drawings.

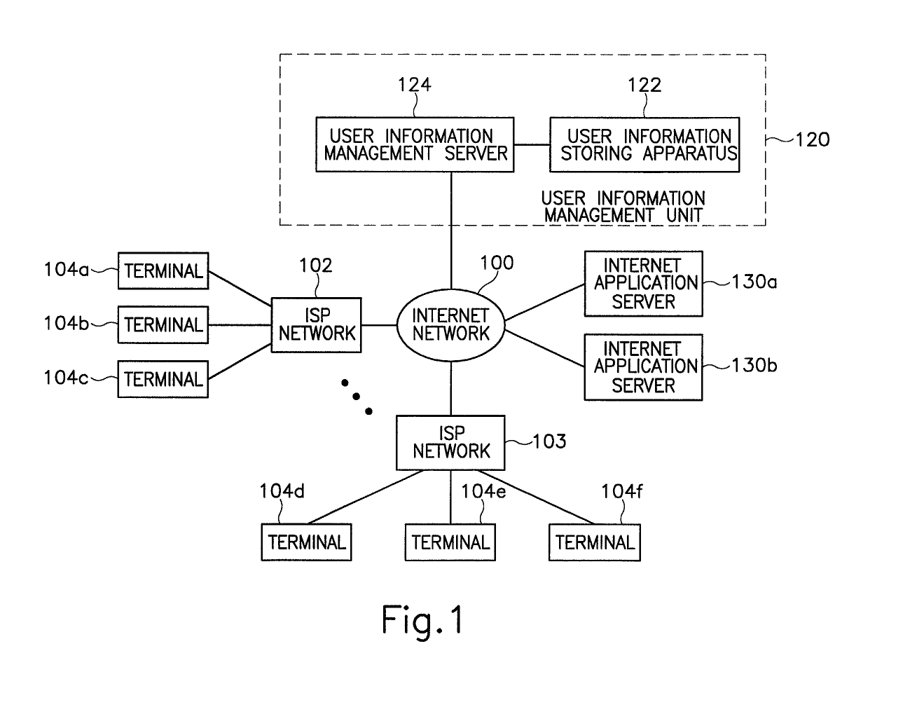

FIG. 1 is a view illustrating the construction of a communication environment and network for a communication based on a personal identifier according to the present invention which includes internet service provider networks 102 and 103, terminals 104a through 104f, a user information management unit 120 and more than one internet application servers 130a and 130b.

As shown in FIG. 1, the internet service provider networks (ISP networks) 102 and 103 are connected with an internet network 100 for providing an internet connection service, a web site establishment and a web hosting service to a personal or a company.

The terminals (for example, a personal computer, a web server, etc.) 104a through 104f each include an internet protocol and internet application function and are connected with the internet network 100 based on a static internet protocol address or a dynamic internet protocol address allocated by the internet service provider.

The user information management unit 120 is connected with the internet network 100 and provides and manages a personal identifier and a user's terminal information and an internet application host information.

The internet application servers 130a and 130b execute an internet application program in the internet 100 and has a user account by the service of an application such as a personal web service or an e-mail service.

A personal identifier of an internet user is unique in the internet and may have a certain type. In the present invention, a user's name formed in an existing URL (Uniform Resource Locator) type is connected with a domain name of a server which provides a certain user information management service for thereby obtaining a domain name of a certain internet host.

The user information management unit 120 includes a user information storing apparatus 122 and a user information management server 124.

The user information storing apparatus 122 stores a user information in an object-oriented database type, a relational database type or a directory server type.

The user information management server 124 is connected with the internet network 100 for thereby managing a user information and obtaining a security and verification with respect to a user information of the user information storing apparatus 122.

The user information management unit 120 manages and provides a upon request for the user's information that the user wants to receive.

At this time, the user information management unit 120 manages the terminals 104a through 104f used by the user for an internet application based on a personal identifier and the names of the internet application servers 130a and 130b which support the internal applications.

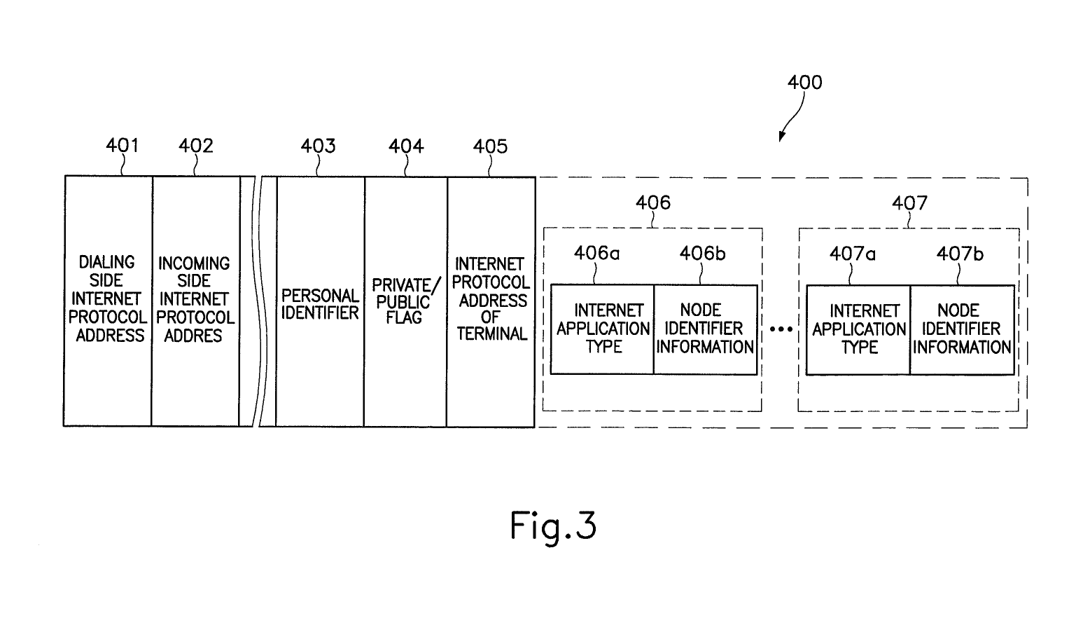

A user information management protocol is performed between the user and the user information management unit 120 for the above-described user information management. The user information management protocol will be explained with reference to FIGS. 3 through 6.

The user management server 124 and the internet application servers 130a and 130b have a static internet protocol address and a domain name and are connected with the internet for thereby implementing a communication based on an internet protocol address. At this time, the terminals 104a through 104f and the names of the internet application servers 130a and 130b are managed in an internet protocol address or domain name type and the above management is stored in the user information management storing apparatus 122.

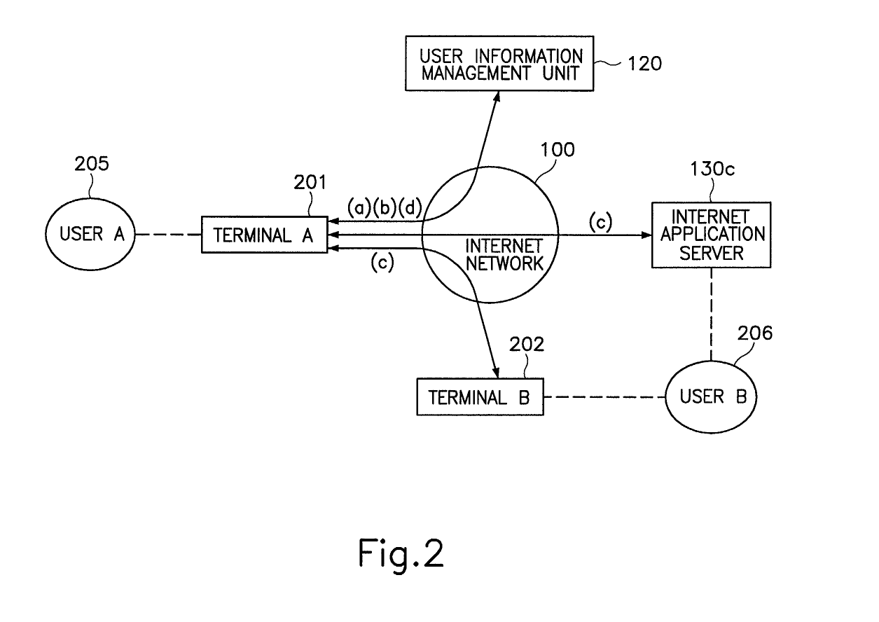

FIG. 2 is a view illustrating an operation by a user information management unit of FIG. 1. Namely, FIG. 2 illustrates operational relationships (a) through (d) between the internet users (user A and user B) 205 and 206 and the user information management unit 120 using a personal identifier in the internet network.

The users (user A and user B) 205 and 206 of FIG. 2 are internet users each having a personal identifier. The terminals (terminal A and terminal B) 201 and 202 of the above users are turned on and have a dynamic internet address or a static internet address.

The users (user A and user B) 205 and 206 transfer a user information service request message, which requests a user information service, to the user information management unit 120 through the terminals (terminal A and terminal B) 201 and 202.

The user information service request is classified into a user information management request “a” for a user information management itself, a user information inquiry request “b” for inquiring a current user information of another user to whom the current user wants to access, and a user information deletion request “d” in which the current user deletes a user information himself registered in the user information storing apparatus 122 based on the user information management request.

In FIG. 2, (a) illustrates a user information management request by which the user A 205 registers a user information into the user information management unit 120 through the terminal A 201;

(b) illustrates a user information inquiry request by which the user A 205 registers a user information of the user B 206 into the user information management unit 120;

(c) illustrates a communication between the terminal A 201 and the terminal B 202 or the terminal A 201 and the internet application server 130 which use a user information verified by the user information management unit 120; and

(d) illustrates a user information deletion request by which a personal identifier of the user A 205 and information of the terminal A 201 or the internal application server 130c corresponding to the user information are deleted from the user management information system 120.

FIG. 3 illustrates the construction of a user information internet protocol packet 400 for a user information registration of FIG. 2 in which in the case that a user transfers a user information, the user stores a user information into the user information internet protocol packet 400 of a packet data unit (PDU) and transfers the same.

As shown in FIG. 3, there are provided a dialing side internet protocol address 401, an incoming side internet protocol address 402, a personal identifier 403, a private/public network flag 404, a terminal internet address 405, internet application types 406a and 407a and node identifier information 406b and 407b.

The dialing side internet protocol address 401 of FIG. 3 represents an internet protocol address of the terminal that the current user is connected.

The incoming side internet protocol address 402 represents an internet protocol address of the incoming side terminal which receives a packet, namely, an internet protocol address of the user information management server 124.

The dialing side internet protocol address 401 and the incoming side internet protocol address 402 exist in an internet protocol program header and are set by a terminal or a proxy terminal. The user does not set the same.

The personal identifier 403 represents a personal identifier of a user who wants to register a user information based on the personal identifier allocated to each user.

In addition, the private/public network flag 404 represents whether the terminal that a user uses to register a personal information, is connected with a private internet protocol network or a public internet protocol network.

In the case that the user terminal is connected with the public internet network, the internet protocol address 405 of the terminal represents a public internet protocol address of the terminal. In addition, in the case that the user terminal is connected with the private internet protocol network, it represents a public internet protocol address allocated to a gateway which connects the private network and the public internet network.

For example, in the case that the user terminal 104a through 104f, 201 and 202 are connected with the private internet protocol network, the private/public flag value is 1, and the internet protocol address 405 of the terminal is a public internet protocol address allocated from the gateway between the private network and the public network.

In addition, the internet application types 406a and 407a represent the types of the internet application performed by the user. If the user operates the web server, the types 406a and 407a of the internet application represent a web service.

The node identifier information 406b and 407b represent the uniform resource locator (URL) of a corresponding web page in the case that the types 406a and 407a of the internet application are a web service.

The internet application types 406a and 407a and the node identifier information 406b and 407b are selective and are transferred to one of the blocks 406 and 407. In the case that the currently operated internet application types are more than one, the internet application types 406a and 407a and the node identifier information 406b and 407b are transferred to a plurality of blocks, respectively.

The internet protocol address 405 of the terminal has a known internet protocol address format, and the internet application types 406a and 407a and the node identifier information are basically formed in an ASCII format.

The user information management unit 120 stores an information (user information) of the user information internet protocol packet 400 which is received using a personal identifier as a key into the user information storing apparatus 122.

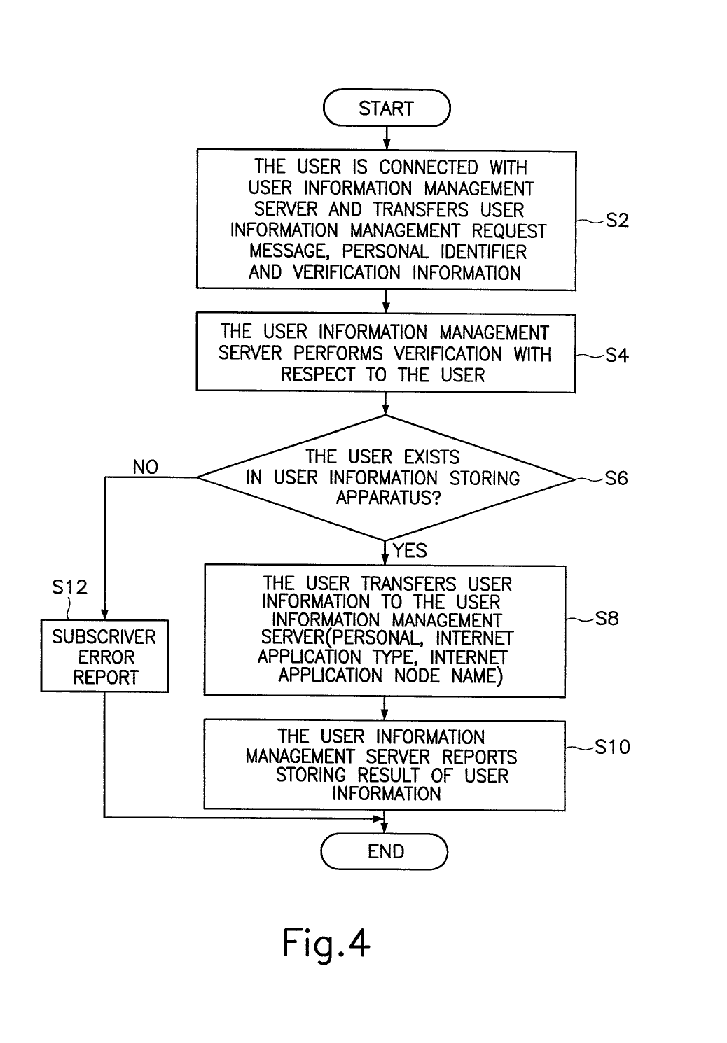

FIG. 4 is a flow chart illustrating an operation procedure based on a user information management request (a) of FIG. 2, namely, a procedure in which the user information management unit 120 receives a user information of the current user A 205 and register a user information by connecting with the internet.

If another user wants to communicate with the user A 205, the user information of the user A 205 is received from the user information management unit 120.

The user information management unit 120 receives a user information processing request message, a personal identifier and a verification information (for example, password) needed for a user verification from the user A 205 through the terminal A 201 (S2).

A verification with respect to the user A 205 is performed with respect to the user information management request message, the personal identifier and the verification information of the user A 205 (S4).

It is judged whether the user A 205 exists in the user information storing apparatus 122 based on the user verification (S6). If the user A 205 does not exist therein, a subscriber error report is outputted (S12).

As a result of the judgement, if the user A 205 exists therein, the user information management request of the user A 205 is performed for thereby permitting a user information registration of the user A, and an information of the user's current terminal and a user information including an internet application type and the name of an application node are received (S8).

The user information received from the user A 205 is stored in the service storing apparatus 122, and a result of the storing is transferred to the terminal A 201 (S10).

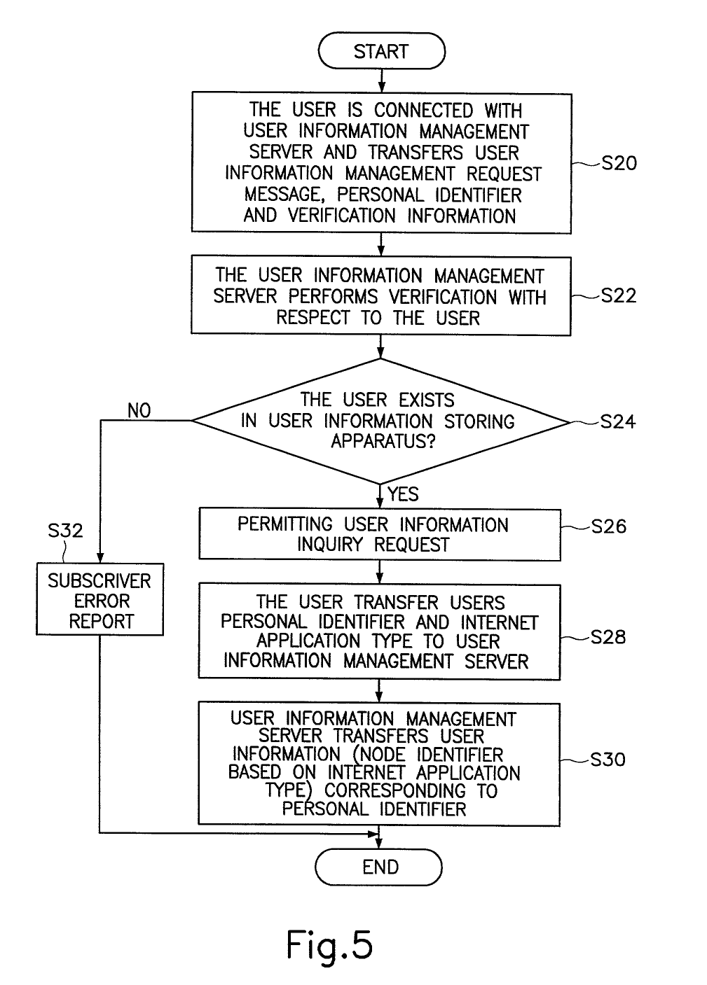

FIG. 5 is a flow chart illustrating an operation procedure based on a user information inquiry request (b) of FIG. 2. Namely, the user A205 inquires a user information of the user B206 to the user information management unit 120.

The user A 205 is connected with the user information management server 124 through the terminal A 201 and transfers a user information inquiry request message, a personal identifier and a verification information(for example, password, etc.) needed for a user verification of the user information management server 124 (S20).

The user information management server 124 which received the user information inquiry request message, the personal identifier and the verification information of the user A 205 performs a verification with respect to the user A 205 (S22) and judges whether the user A 205 exists in the user information storing apparatus 122 (S24).

As a result of the judgement, if the user A 205 does not exist therein, a subscriber error report is outputted (S32), and if the user A 205 exists therein, the user information inquiry request of the user A 205 is received (S26).

The user A 205 transfers the personal identifier of the user B 206 and the type of the internet application to the user information management unit 120 (S28), and the user information management server 120 searches a user information of the current user B 206 corresponding to the personal identifier through the user information storing apparatus 122 and transfers the user information of the user B 206 that the user A 205 wants to the terminal A 201 (S30).

The user A 205 accesses the currently used terminal B 202 of the user B 206 and the internet application server 130c of the user B 206 using the user information of the user B 205 and communicates with the user B 206 in real time.

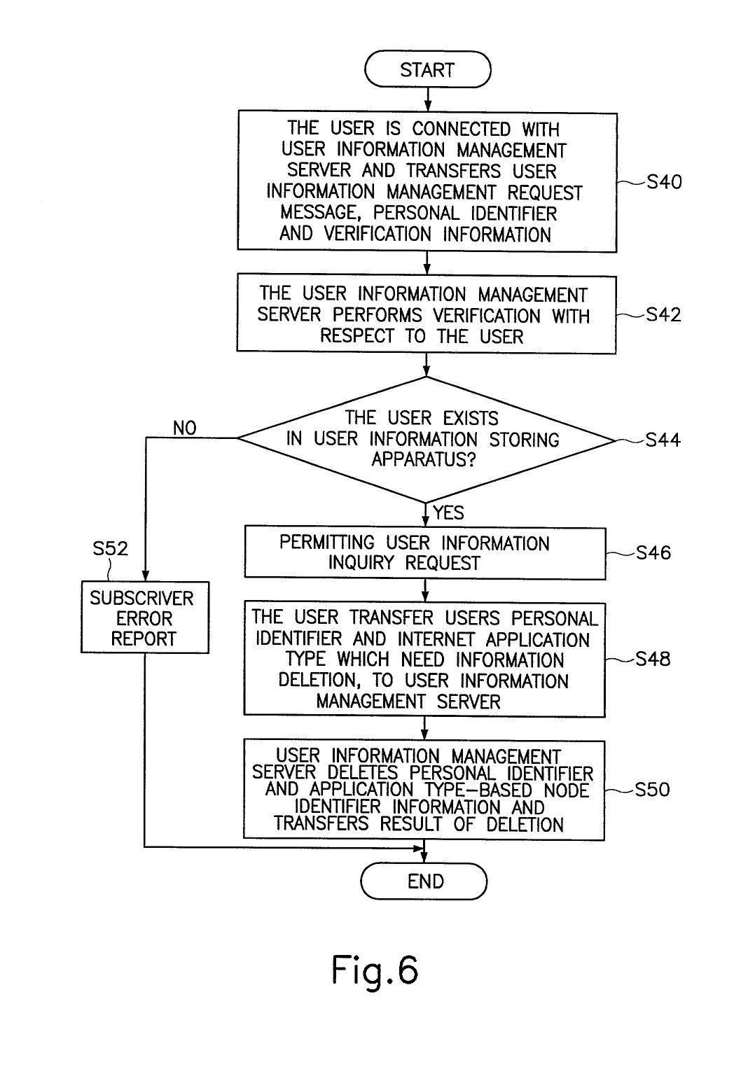

FIG. 6 is a flow chart illustrating an operation procedure based on a user information deletion request (d) of FIG. 2. Namely, FIG. 6 illustrates a procedure for deleting an information of the terminal A 201 or the internet application server 130c corresponding to the personal identifier and user information registered through the procedure of FIG. 4 from the user information management unit 120.

The user A 205 is connected with the user information management server 124 through the terminal A 201 and transfers a user information deletion request message, a personal identifier and a verification information (for example, password, etc.) needed for a user verification of the user information management server 124 (S40).

The user information management server 124 which received the user information deletion request message, the personal identifier and the verification information of the user A 205 performs a verification with respect to the user A 205 (S42), and it is judged whether the user A 205 exists in the user information storing apparatus 122 (S44).

As a result of the judgement, if the user A 205 does not exist therein, a subscriber error report is outputted (S52), and if the user A 205 exists therein, the user information deletion request of the user A 205 is permitted (S46).

The user A 205 transfers the personal identifier information, the type of the internet application and the node identifier information to the user information management server 124 (S48), and the user information management server 124 searches a user information corresponding to the personal identifier information through the user information storing apparatus 122 and deletes the searched information, and a result of the deletion is transferred to the terminal A 201 (S50).

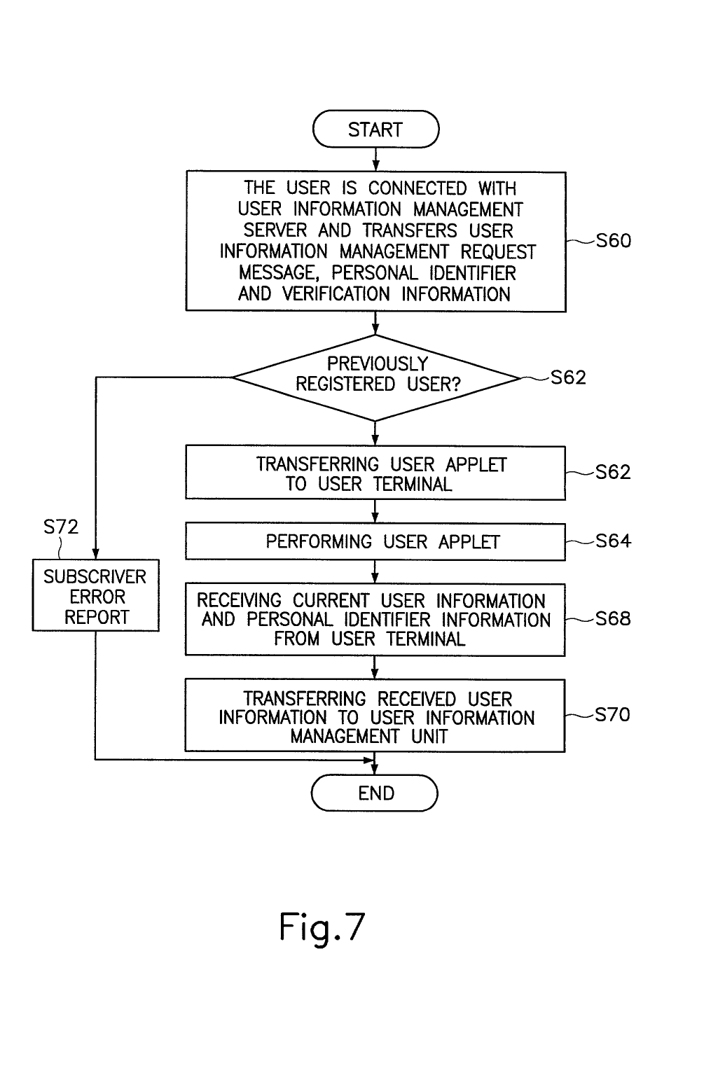

FIG. 7 is a flow chart illustrating an operation procedure of a user information management request of FIG. 2. Namely, FIG. 7 illustrates a procedure that a user information is registered through a registration web server (not shown) which executes a user applet for a user verification and user information registration.

The registration web server is connected with the user terminals 104a through 104f, 201 and 202 and receives a personal identifier of a user and a verification information (for example, password, etc.) needed for a user verification from the user terminals 104a through 104f, 201 and 202 (S60).

A user verification is performed based on the received personal identifier and verification information, and it is judged whether the user is a previously registered user (S62). If the user is not the previously registered user, a subscriber error report is outputted (S72).

As a result of the judgement, if the user is a previously registered user, the user applet is transferred to the user terminals 104a through 104f, 201 and 202 (S64), and the user applet is executed (S66).

The personal identifier information and the current user information are received from the user terminals 104a through 104f, 201 and 202 based on the user applet in the format of FIG. 3 (S68).

The received user information is transferred to the user information management unit (120)(S70).

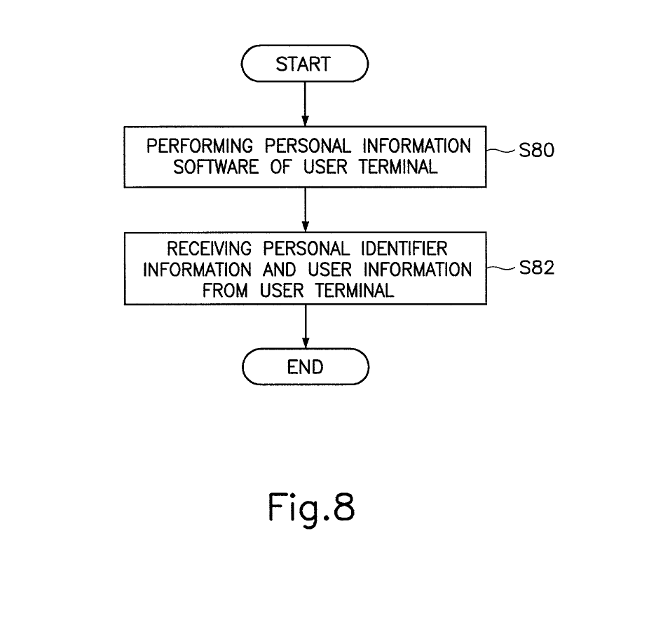

FIG. 8 is a flow chart illustrating another example of the user information transfer procedure (S8) of FIG. 4. Namely, FIG. 8 illustrates a procedure that a personal information software which is an exclusive software for a user information registration is executed by the user terminals 104a through 104f, 201 and 202 for thereby registering the user information.

First, the personal information software of the user terminals 104a through 104f, 201 and 202 are executed (S80).

The personal identifier information and the current user information are received from the user terminals 104a through 104f, 201 and 202 by the personal information software in the format of FIG. 3 (S82).

Another user is connected with the internet application service which is operated by the current user using a personal identifier information of the user through each user information registration procedures of FIGS. 4, 7 and 8.

The user information management unit 120 is connected with the internet application service through the node identifier information 406b and 407b when the user requests an inter-working with the internet application service of a certain user when the user information inquiry is requested (b).

Namely, the user information management unit 120 sets a mapping interrelation information of the types 406a and 407a of the internet application and the node identifier information 406b and 407b with respect to the personal identifier of the user.

The user information management unit 120 inter-works with the internet application of the user using the node identifier information through the above mapping interrelation information when the inter-work with the internet application of the user is requested when a user information inquiry of the user is requested by other user.

For example, in the case that “john.person.net” is registered in the user information management unit 120 as a personal identifier information of the user B 206, and “www.hanmir.com./˜john” which is his home page URL is registered as the node identifier information 406b and 407b, when the user A 205 is connected through “john.person.net” which is the personal identifier information of the user B 206, the current URL is reset to “www.hanmir.com./˜john” for thereby connecting with the homepage of the user B 206.

In another embodiment of the present invention, the user information management unit 120 connects a user with another user using a user's mobile phone using a personal identifier even when the user does not exist in the internet.

Namely, when the user information inquiry (b) is requested, in the case that a communication session connection with a mobile communication terminal of another user which is an inquiry object of the user is requested, the user information management unit 120 sets a communication session and connects the user and the mobile communication terminal.

At this time, the types 406a and 407a of the internet application of the user is a mobile phone, and the node identifier information 406b and 407b are the identifiers (for example, phone number, terminal inherent number, etc.) of the mobile phone.

Therefore, in the case that another user requests a connection with the user through the personal identifier information of the user, the user management information 120 recognizes an identifier information of the mobile phone through the node identifier information 406b and 407b.

The identifier information of the mobile phone is connected with the communication system, and a communication session to the mobile phone of the user is set based on an inter-working with the mobile communication network through the gateway in the internet.

The user information management server 124 according to the present invention transfers the internet protocol address through the user identifier. In the case of the existing DNS server, the user information management server 124 transfers the internet protocol address through the host name. If the user identifier is formed in the same format as the host name, the user management server 124 is capable of performing a function of the DNS server.

Therefore, the users managed by the user information management unit 120 perform a communication with other users using the personal identifier by a simple DNS operation of the user information management server 124.

As described above, an internet communication is implemented based on a personal identifier information in an internet network, and an internet access is implemented based on only a personal identifier irrespective of a location of an internet user and a terminal type of the user.

In addition, it is possible to designate an information concerning a URL of various home pages, an e-mail account, etc. used by the user and a user's terminal using a personal identifier, so that a mobility of a user is supported, and a real time communication between the users is obtained. In addition, it is possible to use various internet application services (home page, e-mail, etc.) that the user has in the internet using a personal identifier information.

In addition, it is possible to communicate with a certain user through an inter-working with a communication system using a personal identifier information even when a user does not exist in the internet.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In an apparatus providing a communication between users using a terminal connected with an internet network based on a connection with an internet service provider network by receiving a static internet protocol address or a dynamic internet protocol address, an apparatus providing a communication service based on a personal identifier in an internet network, comprising:
a user information management means connected with the internet network for providing a unique personal identifier to a user and providing a communication service based on the personal identifier information, wherein said user information management unit includes:
a user information service unit for verifying a user information based on the personal identifier information and providing a service that a user wants, to a user's terminal through the internet network; and
a user information storing unit connected with the user information service unit for storing the personal identifier and user information.

2. The apparatus of claim 1, wherein said user information storing unit stores a user information which represents a current connection state of a user, wherein said user information includes a personal identifier of a user, an internet protocol address of a terminal which is currently used by the user, and an internet application service information which is currently used by the user for an internet application.

3. The apparatus of claim 2, wherein said internet application service information includes a mobile communication information including an identifier of a mobile communication terminal of a current user.

4. The apparatus of claim 1, wherein said personal identifier is used in the same form as an existing domain name by combining a user identifier and a domain name of the user information management means.

5. The apparatus of claim 1, further comprising means connected with the user information management unit for transferring a user applet to a user terminal and receiving the user information.

6. The apparatus of claim 1, wherein said user information management unit receives a user information from the user terminal which includes a personal information software for registering a user information.

7. In an apparatus providing a communication between users using a terminal connected with an internet network based on a connection with an internet service provider network by receiving a static internet protocol address or a dynamic internet protocol address, a method for providing a communication service based on a personal identifier in an internet network, comprising:
a user information service providing step in which an internet network is connected for providing a unique personal identifier to a user and providing a communication service based on the personal identifier information, wherein said user information service providing step includes:
a first step for receiving a personal identifier information, a verification information and a user information service request message from a user which are needed for a user verification;
a second step for verifying a user based on the personal identifier and verification information;
a third step for performing a user information service based on the type of each user information service request message; and
a fourth step for transferring a result message obtained based on an execution of the user information service to the user in accordance with the type of the user information service request message.

8. The method of claim 7, wherein said user information service request message of the third step includes:
a user information management request message for requesting a user information management;
a user information inquiry request message for inquiring the information of other user who the user wants to communicate; and
a user information deletion request message for deleting a registered user information by a user information management request.

9. The method of claim 7, wherein said third step includes:
a step for receiving a user information packet including a user information of the current user from the user terminal when the type of the user information service request message is a user information management request;
a step for extracting and storing a user information and a personal identifier information of the user from the user information packet received; and
a step for generating a user information registration message which reports that the user information and the personal identifier information are registered.

10. The method of claim 7, wherein said third step includes:
a step in which the user information registration unit receives a personal identifier of a user and a verification information needed for a user verification from the user terminal when the type of the user information service request message is a user information management request;
a step for verifying a user based on the personal identifier received and the verification information;
a step in which the user information registration unit transfers a user applet to the user terminal, and the user applet is performed;
a step for receiving a user information packet including a user information of the current user from the user terminal based on the user applet;
a step for transferring the received user information packet to the user information management unit; and
a step for generating a user information registration message which reports that the user information and the personal identifier information are registered.

11. The method of claim 7, wherein said third step includes:
a step for receiving a personal identifier of a user and a verification information needed for the user identification from the user terminal based on a connection with the user terminal including a personal information software when the type of the user information service request message is a user information management request;
a step for verifying a user based on the personal identifier and verification information;
a step for executing a personal information software of the user terminal;
a step for receiving a user information packet including a user information of the current user from the user terminal based on the personal information software; and
a step for generating a user information registration message which reports that the user information and personal identification information are registered.

12. The method of claim 9, wherein said user information packet includes:
a dialing side internet protocol address which represents an internet protocol address of a terminal of the current user;
an incoming side internet protocol address which represents an internet protocol address of the user information management unit for receiving the user information packet;
a personal identifier which represents a user's personal identifier;
a private/public network flag which represents whether the terminal of the user exists in a private internet protocol network or in a public internet;
a terminal internet protocol address which represents a public internet protocol address of the terminal in the case that the terminal exists in the public internet and which represents a public internet protocol address allocated to a gateway which connects the private network and public internet network when the terminal exists in the private internet protocol network;
an internet application type which represents the type of the internet application operated by the user; and
a node identifier information which represents an internet protocol address information based on the type of the internet application.

13. The method of claim 12, wherein said internet application types and node identifier information are provided in multiple numbers based on the number of the internet applications operated by the user.

14. The method of claim 12, wherein said type of the internet application includes a mobile communication type of the current user, and the node identifier information further includes an identifier of the mobile communication terminal.

15. The method of claim 7, wherein said third step includes:
a step for receiving a personal identifier of other user which is an object of the user information inquiry and an information with respect to the type of the internet application which will be serviced when the type of the user information service request message is a user information inquiry request;
a step for searching a user information of a user which is an inquiry object based on the received personal identifier information and the internet application service type information; and
a step for generating a user information message based on the user information corresponding to the personal identifier.

16. The method of claim 15, wherein said user information search step includes:
a step for searching a node identifier information corresponding to the internet application service type when the internet application service type information is an inquiry request with respect to the internet application type;
a step for searching a node identifier information corresponding to the internet application service type when the internet application service type is a request with respect to an inter-working with the internet application service; and
a step for searching an identifier information of the identifier information of the node identifier information corresponding to the internet application service type when the internet application service type information is a connection request with a communication session.

17. The method of claim 7, wherein said third step includes:
a step for receiving a personal identifier information of a user and a user information from the user when the type of the user information service request message is a user information deletion request;
a step for searching and deleting a personal identifier and a user information corresponding to the personal identifier information and user information received from the user; and
a step for generating a user information deletion message which represents that a user information of the user is deleted.

18. The method of claim 7, further comprising:
a step for searching a mapping relationship information of the type of an internet application and a node identifier information with respect to a personal identifier of other user which is an object of the inquiry when the user information service request message type is an internet service inter-working request among the user information inquiry requests when transmitting a result message in the fourth step; and
a step for connecting the user's terminal which requested an inquiry through the mapping relationship information to an internet application service of the other user.

19. The method of claim 7, further comprising:
a step for searching a mobile communication service type of the current user based on the type of the internet application with respect to a personal identifier of other user which is an object of the inquiry when the type of the user information service request message is a request of a connection with a communication session among the user information inquiries when transferring a result message in the fourth step;
a step for searching an identifier information of the mobile communication terminal based on the mobile communication service type through the node identifier information of other user;
a step for connecting with a communication system using an identifier information of the mobile communication terminal;
a step for setting a communication session to the mobile communication terminal based on an inter-working with the mobile communication network through the gateway of the internet; and
a step for connecting the terminal of a user who requested an inquiry through the communication session and the mobile communication terminal.
